(19) United States
(12) Patent Application Publication
(10) Pub. No.: US 2025/0139817 A1
(43) Pub. Date: May 1, 2025

(54) TRAINING APPARATUS, ANGLE ESTIMATION APPARATUS, TRAINING METHOD, AND ANGLE ESTIMATION METHOD

(71) Applicant: NEC Corporation, Minato-ku, Tokyo (JP)

(72) Inventors: Tsenjung Tai, Tokyo (JP); Masato Toda, Tokyo (JP)

(73) Assignee: NEC Corporation, Minato-ku, Tokyo (JP)

(21) Appl. No.: 18/730,445

(22) PCT Filed: Feb. 2, 2022
(86) PCT No.: PCT/JP2022/004092

§ 371 Date: Jul. 19, 2024

(51) Int. Cl. G06T 7/73; G06V 10/77

(52) U.S. Cl. CPC G06T 7/73; G06V 10/7715; G06T 2207/20081

(57) ABSTRACT

The training apparatus includes an angle difference computation section which calculates a difference between angles estimated by one or more angle estimators, a rigid transformation section which transforms the feature of the input image according to the difference, a matching loss computation section which calculates a matching loss between a non-transformed feature extracted by the one or more feature extractors and the feature transformed by the rigid transformation section, and an updating section which updates at least the one or more angle estimators with reference to the matching loss, wherein the rigid transformation section transforms the feature in a way that the feature appears as if it has been extracted from an image at the same angle of the image from which the non-transformed feature value has been extracted.

### TECHNICAL FIELD

The present invention relates to a training apparatus, an angle estimation apparatus, a training method, and an angle estimation method.

### BACKGROUND ART

Angle information is useful for training a SAR (synthetic aperture radar) object classifier. It is especially helpful when the data is limited. Angle information is also helpful for tasks related to optical images. One example of the tasks related to optical images is face recognition or object recognition.

An angle estimator can estimate the angle information from an input image. The angle information can be the following but not limited to: the object pose of an object in the image, or the shooting angle of the camera which produces the image. Angle information helps increase the performance of a classifier. For example, a classifier only trained with two images at angles A and B without knowing the angle information can only function on images at angles A and B. Nevertheless, a classifier trained with the same images with knowledge of their angle information can function on images at angles other than A and B by interpolating the image information between angles A and B. In face recognition and object recognition, if angle information is available, it is possible to guess how an object looks like if the object is viewed at a new angle, even if there is no training data at that new angle available.

In order to increase the accuracy of the angle estimator, the angle estimator is trained by machine learning methods. There is a method of using ground truth angle labels to train the angle estimator (for example, refer to Non-Patent Literature 1). In the method, images and their ground truth image labels are first input. Next, an angle estimator, which is a learnable neural network, estimates the angles from images. Further, a penalty is computed as the value difference between the estimated angles and the ground truth angles. Furthermore, the angle estimator is updated according to the penalty. After thousands of iterations of updates, the angle estimator estimates angles that match the ground truth angle labels.

Another method is to use ground truth structural data (for example, refer to Non-Patent Literature 2). In the method, images and their ground truth structure data are first input. Next, features are extracted from two-dimensional (2D) images using a learnable feature extractor. Further, angles are estimated from the 2D images using a learnable angle extractor. Furthermore, the structural data is projected according to the estimated angles to obtain the projected features. Then, a penalty is computed as the value difference between the extracted features and the projected features. Afterward, the feature extractor and the angle estimator are updated according to the penalty. After thousands of iterations of updates, the angle estimator estimates angles that make the projected features match the extracted features.

### CITATION LIST

### Patent Literature

[NPL 1] S Tulsiani et al., “Viewpoints and keypoints”, In Proceedings of the IEEE Conference on Computer Vision and Pattern Recognition, 2015, pp. 1510-1519
[NPL 2] G Pavlakos et al., “6-dof object pose from semantic keypoints”, May 2017, In 2017 IEEE international conference on robotics and automation (ICRA), pp. 2011-2018

### SUMMARY OF INVENTION

### Technical Problem

In the method using ground truth angle labels, supervision from angle labels is required. In the method using ground truth structural data, supervision from structural data is required. It is desirable to train an angle estimator without using any supervision such as angle labels or structural data.

Thus, the purpose of the present invention is to provide a training apparatus, an angle estimation apparatus, a training method, and an angle estimation method capable of training a model with respect to angle estimation without using any annotation.

### Solution to Problem

An exemplary aspect of a training apparatus includes one or more feature extraction means for extracting features from input images, one or more angle estimation means for estimating angles from the input images, angle difference computation means for calculating a difference between angles estimated by the one or more angle estimation means, rigid transformation means for transforming the feature of the input image according to the difference, matching loss computation means for calculating a matching loss between a non-transformed feature extracted by the one or more feature extraction means and the feature transformed by the rigid transformation means, and updating means for updating at least the one or more angle estimation means with reference to the matching loss, wherein the rigid transformation means transforms the feature in a way that the feature appears as if it has been extracted from an image at the same angle of the image from which the non-transformed feature value has been extracted.

An exemplary aspect of an angle estimation apparatus includes an angle estimation means for estimating an angle from an input image, wherein the angle estimation means has been trained together with one or more feature extraction means and rigid transformation means, in such a way as the extracted image feature, after being transformed according to the estimated angle, appears as if it was extracted from an image at an angle different from the original input image.

An exemplary aspect of a training method includes extracting features from input images, estimating angles from the input images by one or more angle estimation means, calculating a difference between estimated angles, rigid-transforming the extracted feature of the input image according to the difference, calculating a matching loss between a non-transformed feature and the rigid-transformed feature, and updating at least the one or more angle estimation means with reference to the matching loss, wherein the transformed feature is transformed in a way that it appears as if it has been extracted from an image at the same angle of the image from which the non-transformed feature has been extracted.

An exemplary aspect of an angle estimation method includes estimating the angle from an input image, using an angle estimation apparatus which has been trained together with one or more feature extraction means and rigid transformation means, in such a way as the extracted image feature, after being transformed according to the estimated angle, appears as if it was extracted from an image at an angle different from the original input image.

An exemplary aspect of a training program causes a computer to execute extracting features from input images, estimating angles from the input images by one or more angle estimation means, calculating a difference between estimated angles, rigid-transforming the feature of the input image according to the difference, calculating a matching loss between a non-transformed feature and the rigid-transformed feature, and updating at least the one or more angle estimation means with reference to the matching loss, wherein the transformed feature is transformed in a way that it appears as if it has been extracted from an image at the same angle of the image from which the non-transformed feature has been extracted.

An exemplary aspect of an angle estimation program causes a computer to execute estimating the angle from an input image, using an angle estimation apparatus which has been trained together with one or more feature extraction means and rigid transformation means, in such a way as the extracted image feature, after being transformed according to the estimated angle, appears as if it was extracted from an image at an angle different from the original input image.

### Advantageous Effects of Invention

The present invention allows training with respect to angle estimation without using any annotation related to angle or object structure.

### BRIEF DESCRIPTION OF DRAWINGS

FIG. 1 is a block diagram showing a configuration example of a training apparatus of the first example embodiment.

FIG. 2 is a flowchart showing an operation of the training apparatus of the first example embodiment.

FIG. 3 is an explanatory diagram of function and effect of the training apparatus.

FIG. 4 is a block diagram showing a configuration example of a training apparatus of the second example embodiment.

FIG. 5 is a flowchart showing an operation of the training apparatus of the second example embodiment.

FIG. 6 is a block diagram showing a configuration example of a training apparatus of the third example embodiment.

FIG. 7 is a flowchart showing an operation of the training apparatus of the third example embodiment.

FIG. 8 is a block diagram showing a configuration example of a training apparatus of the fourth example embodiment.

FIG. 9 is a flowchart showing an operation of the training apparatus of the fourth example embodiment.

FIG. 10 is a block diagram showing a configuration example of a training apparatus of the fifth example embodiment.

FIG. 11 is a flowchart showing an operation of the training apparatus of the fifth example embodiment.

FIG. 12 is a block diagram showing a configuration example of an angle estimation apparatus of the sixth example embodiment.

FIG. 13 is a block diagram showing an example of a computer with a CPU.

FIG. 14 is a block diagram showing the main part of a training apparatus.

FIG. 15 is a block diagram showing the main part of an angle estimation apparatus.

### DESCRIPTION OF EMBODIMENTS

Hereinafter, the example embodiment of the present invention is described with reference to the drawings. In each of the example embodiments described below, SAR images are assumed as the images. However, the images are not limited to SAR images. As an example, the input images can also be optical images, for example, images photographed by a smart phone.

### Example Embodiment 1

### Configuration of Training Apparatus

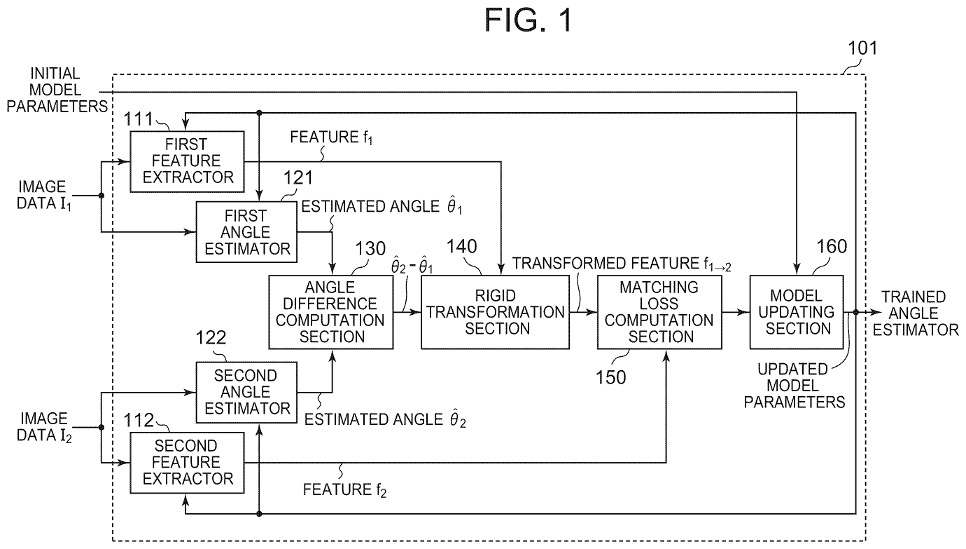

FIG. 1 is a block diagram showing a configuration example of a training apparatus of the first example embodiment.

The training apparatus 101 shown in FIG. 1 comprises a first feature extractor 111, a second feature extractor 112, a first angle estimator 121, a second angle estimator 122, an angle difference computation section 130, a rigid transformation section 140, a matching loss computation section 150, and a model updating section 160.

In FIG. 1 and the other figures, unidirectional arrows are used, but the unidirectional arrows are intended to represent the flow of data in a straightforward manner, and are not intended to exclude bidirectionality.

Image data I₁ is inputted to the first feature extractor 111 and the first angle estimator 121. Image data I₂ is inputted to the second feature extractor 112 and the second angle estimator 122. The image data I₁ and I₂ may be a batch of images. An image corresponding to image data I₁ is referred to as the first image. An image corresponding to image data I₂ is referred to as the second image. Note that the first feature extractor 111 and the second feature extractor 112 can be configured as a single section. The first angle estimator 121 and the second angle estimator 122 can also be configured as a single section.

A relation of the first image corresponding to the input image data I₁ and the second image data corresponding to the input image data I₂ is as follows. The second image has a different angle from the first image. As an example, the second image may be an image which contains a same object or contains another object from the same class category as the first image, but has been taken at a different view (shooting angle or viewing angle) from the first image. The first image and second image may be taken at the same time or at different times.

The first feature extractor 111 extracts a feature f₁ from the input image data I₁. The second feature extractor 112 extracts a feature f₂ from the input image data I₂. The first angle estimator 121 estimates an angle θ\hat{ }₁ from the input image data I₁. The second angle estimator 122 estimates an angle θ\hat{ }₂ from the input image data I₂. Hereinafter, θ\hat{ }₁ and θ\hat{ }₂ are referred to as the estimated angles. The angle difference computation section 130 calculates the difference Δθ=θ\hat{ }₂−θ\hat{ }₁ . Note that θ\hat{ } is equivalent to the following expression.

### Math. 1

The rigid transformation section 140 applies rigid transform according to Δθ to the feature f₁ of the first image to transform the feature f₁ into a novel feature f_{1 to 2} as if the novel feature is extracted from an image at the same view as the second image. For example, the rigid transformation section 140 transforms the feature f₁ of the input image data I₁ by rotating the feature f₁ in any axis and by any angle. The feature f₁ may be transformed using other transformation methods, as long as it is transformed as if a new feature will be extracted.

The matching loss computation section 150 calculates a matching loss between a feature extracted from a first image through rigid body transform and a feature extracted from the second image. The model updating section 160 updates at least one of the learnable feature extractors 111, 112 and the learnable angle estimators 121, 122 with reference to the matching loss in a way that the transform novel feature f_{1 to 2} matches the non-transformed feature f₂.

### Operation of Training Apparatus

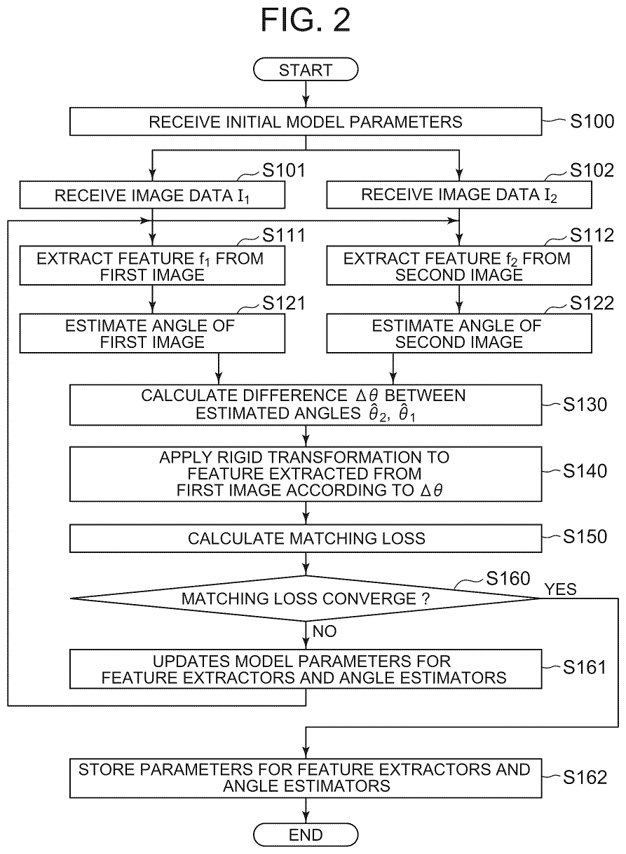

Next, the operation of the training apparatus 101 will be explained with reference to the flowchart in FIG. 2.

The training apparatus 101 receives initial model parameters (step S100). The initial model parameters include initial model parameters for the first feature extractor 111, the second feature extractor 112, the first angle estimator 121, and the second angle estimator 122. The received initial model parameters are supplied to the first feature extractor 111, the second feature extractor 112, the first angle estimator 121, and the second angle estimator 122.

The training apparatus 101 receives input image data I₁ (step S101). The first feature extractor 111 extracts a feature f₁ from the first image (step S111). The first angle estimator 121 estimates an angle of the first image (step S121). The first angle estimator 121 outputs estimated angle θ\hat{ }₁.

The training apparatus 101 receives input image data I₂ (step S102). The second feature extractor 112 extracts a feature f₂ from the second image (step S112). The second angle estimator 122 estimates an angle of the second image (step S122). The second angle estimator 122 outputs estimated angle θ\hat{ }₂.

Note that the process of step S111 and the process of step S112 can be executed simultaneously. The process of step S111 and the process of step S121 can be executed simultaneously. The process of step S112 and the process of step S122 can be executed simultaneously.

The angle difference computation section 130 calculates the difference 40 between the estimated angles θ\hat{ }₁ and θ\hat{ }₂ (step S130). The rigid transformation section 140 applies rigid transform according to Δθ to the feature f₁ extracted from the first image to transform it into a novel feature f_{1 to 2} as if the novel feature is extracted from an image at the same view as the second image (step S140).

The matching loss computation section 150 calculates |f_{1 to 2}−f₂| as a matching loss (S150). The model updating section 160 determines whether the matching loss converged or not (S160). When the matching loss is converged (Yes in the step S160), the process proceeds to the step S162. When the matching loss is not converged (No in the step S160), the process proceeds to the step S161. For example, the model updating section 160 compares the matching loss with a predetermined threshold to determine whether the matching loss is converged or not.

In step S161, the model updating section 160 updates model parameters for the first feature extractor 111, the second feature extractor 112, the first angle estimator 121, and the second angle estimator 122, with reference to the matching loss calculated by the matching loss computation section 150. Then, the process returns to step S111, S112.

In step S162, the model updating section 160 stores, in a storage medium (not shown in FIG. 1), the model parameters for the first feature extractor 111, the second feature extractor 112, the first angle estimator 121, and the second angle estimator 122. In particular, the model parameters of the first angle estimator 121 and the second angle estimator 122 correspond to the parameters of the trained angle estimator. In other word, the model updating section 160 can output the trained angle estimator as the final processing result.

### Function and Technical Effects of the Present Example Embodiment

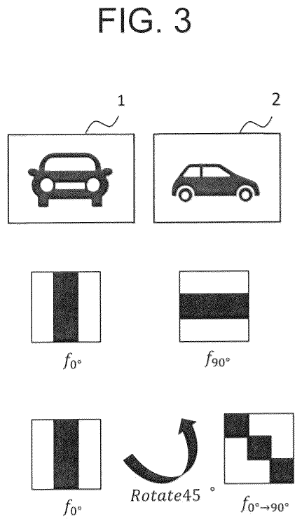

Referring an explanatory diagram of FIG. 3, function and effect of the training apparatus will be explained. The training apparatus of the present example embodiment train an angle estimator (for example, the first angle estimator 121). Then, the trained angle estimator may estimate angles of newly obtained images.

At the training stage, images of objects (for example, an image 1 shown in FIG. 3 corresponding to the first image, and an image 2 shown in FIG. 3 corresponding to the second image) from the same class are provided. These images are shot at different viewing angles. As an example, image 1 shot at angle 0 degree is referred to as I_{0 degree}, and image 2 shot at angle 90 degrees is referred to as I_{90 degrees} (refer to FIG. 3).

Assume the feature extracted from I_{0 degree} is referred to as f_{0 degree} (refer to FIG. 3), and the feature extracted from f_{90 degrees} is referred to as f_{90 degrees}, by an feature extractor (for example, the first feature extractor 111 the second feature extractor 112). f_{0 degree} and f_{90 degrees} are shown in the middle row in FIG. 3 and are expressed by following.

### Math. 2

An angle estimator (for example, the first angle estimator 121, and the second angle estimator 122) estimates angles from image I_{0 degree} and I_{90 degrees}. As an example, assume that the estimated angle θ\hat{ }₁ is 20 degrees and the estimated angle θ\hat{ }₂ is 65 degrees. In this case, the difference Δθ is 45 degrees.

A rigid transformation section rotates f_{0 degree} 45 degrees. The transformed feature f_{0 degree to 90 degrees} is shown in the right of the bottom row in FIG. 3 and is expressed by the following.

### Math. 3

A matching loss between the transformed feature f_{0 degree to 90 degrees} which is transformed from the view 0 degree to 90 degrees and the non-transformed feature f_{90 degrees} at the same view 90 degrees is expressed by the following.

### Math. 4

By updating the angle estimator, or the feature extractor and the angle estimator with reference to the match loss in a way that if the entire computation flow from inputting images to obtaining the matching loss repeats for a sufficiently large number of iterations, the matching loss shall tend to be minimized towards zero.

At the testing or application stage, given a newly obtained image of an object from the same class, the trained angle estimator can estimate it shooting angle correctly.

### Example Embodiment 2

### Configuration of Training Apparatus

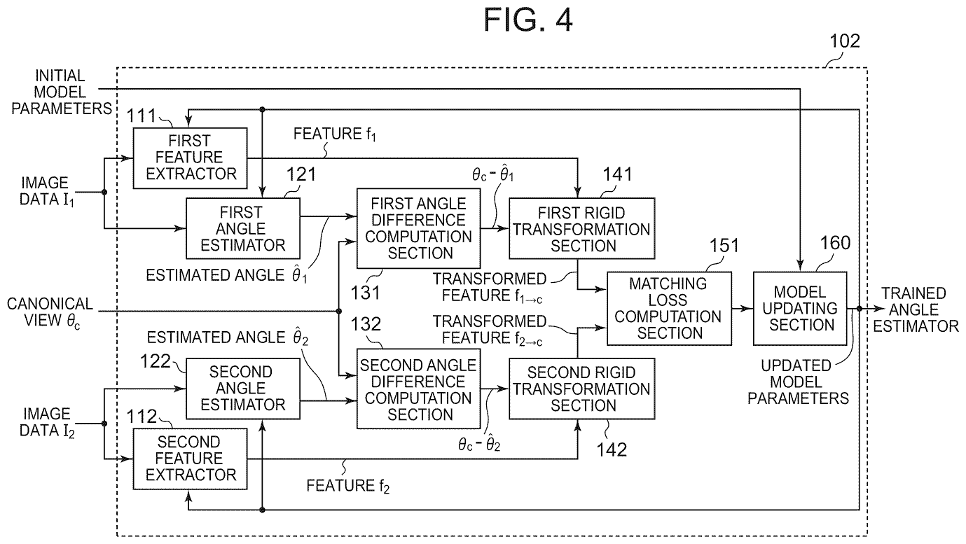

FIG. 4 is a block diagram showing a configuration example of a training apparatus of the second example embodiment. The training apparatus 102 shown in FIG. 4 includes a first angle difference calculation section 131 and a second angle difference calculation section 132 instead of the angle difference calculating section 130 in the first example embodiment. The training apparatus 102 includes a first rigid transformation section 141 and a second rigid transformation section 142 instead of the rigid transformation section 140 in the first example embodiment. The other configuration of the training apparatus 102 is the same as that of the training apparatus 101 of the first example embodiment. Note that the first angle difference calculation section 131 and the second angle difference calculation section 132 can be configured as a single section. The first rigid transformation section 141 and the second rigid transformation section 142 can also be configured as a single section.

In the present example embodiment, an angle θ_{c} of a canonical view is input to the first angle difference computation section 131 and the second angle difference computation section 132. θ_{c} is predetermined by a user. The first angle difference computation section 131 calculates a difference Δθ₁ between θ_{c} and θ\hat{ }₁. The second angle difference computation section 132 calculates a difference Δθ₂ between θ_{c} and θ\hat{ }₂.

The first rigid transformation section 141 applies rigid transform according to Δθ₁ to the feature f₁ extracted from the first image to transform the feature f₁ into a novel feature f_{1 to c}. The second rigid transformation section 142 applies rigid transform according to Δθ₂ to the feature f₂ extracted from the second image to transform the feature f₂ into a novel feature f_{2 to c}.

In the present example embodiment, the matching loss computation section 151 calculates |f_{1 to c}−f_{2 to c}| as a matching loss.

### Operation of Training Apparatus

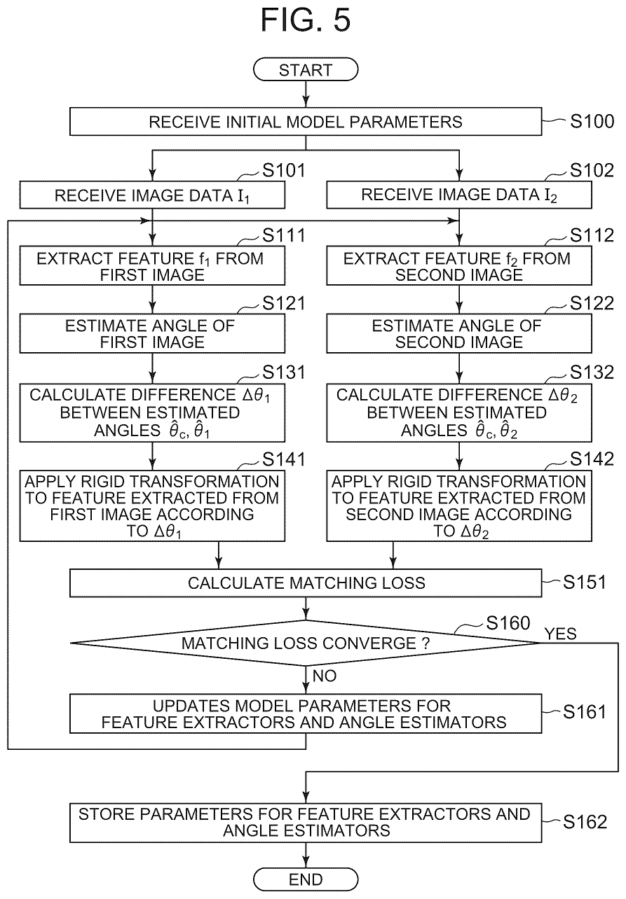

Next, the operation of the training apparatus 102 will be explained with reference to the flowchart in FIG. 5. The operation of steps S100, S101 to S122 and S160 to S162 is the same as it of the training apparatus 101 shown in FIG. 2.

In the present example embodiment, the first angle difference computation section 131 calculates a difference Δθ₁ between θ_{c} predetermined by a user and θ\hat{ }₁ in step S131. The second angle difference computation section 132 calculates a difference Δθ₂ between θ_{c} and θ\hat{ }₂ in step S132.

The first rigid transformation section 141 applies rigid transform according to Δθ₁ to the feature f₁ to transform it into a novel feature f_{1 to c} as if the novel feature is extracted from an image at the canonical view (step S141). The second rigid transformation section 142 applies rigid transform according to Δθ₂ to the feature f₂ to transform it into a novel feature f_{2 to c} as if the novel feature is extracted from an image at the canonical view (step S142).

The matching loss computation section 151 calculates |f_{1 to c}−f_{2 to c}| as a matching loss (step S151).

### Technical Effects of the Present Example Embodiment

Although the angle difference is computed based on the estimated angles for the first input image and the second input image in the first example embodiment, in the present example embodiment, the angle difference is calculated based on the estimated angle for one image, for example the first image or the second image, and a predetermined canonical angle. If the angle estimations are not accurate yet in the first example embodiment, the error of angle difference is 2 units, while in the present example embodiment, the error is 1 unit. In conclusion, the present example embodiment may be more robust than the first example embodiment.

### Example Embodiment 3

### Configuration of Training Apparatus

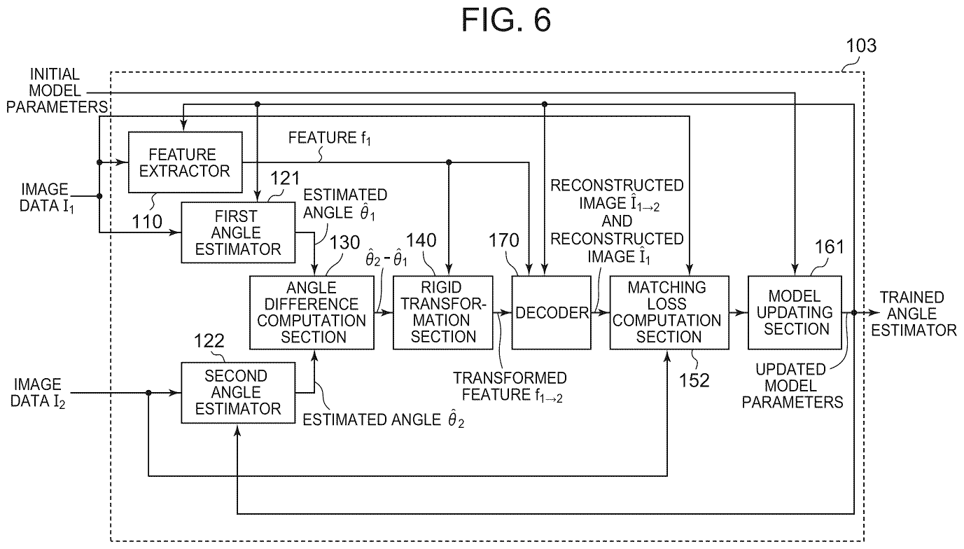

FIG. 6 is a block diagram showing a configuration example of a training apparatus of the third example embodiment. The training apparatus 103 shown in FIG. 6 does not include the second feature extractor 112 in the first example embodiment. The training apparatus 103 further includes a decoder 170 as an example of an image reconstruction means. The other configuration of the training apparatus 103 is the same as that of the training apparatus 101 of the first example embodiment. However, the operation of a matching loss computation section 152 is different from the operation of the matching loss computation section 150 in the first example embodiment. Moreover, the operation of a model updating section 161 is different from the operation of the model updating section 160 in the first example embodiment.

The decoder 170 generates a reconstructed image I\hat{ }_{1 to 2}. The decoder 170 also generates a reconstructed image I\hat{ }₁.

In the present example embodiment, the matching loss computation section 152 calculates a matching loss between I\hat{ }_{1 to 2} and I₂. In addition, the matching loss computation section 152 calculates a matching loss between I\hat{ }₁ and I₁. The model updating section 161 updates at least one of the learnable feature extractor 110 and the learnable angle estimators 121, 122, and the decoder 170 with reference to the matching loss.

### Operation of Training Apparatus

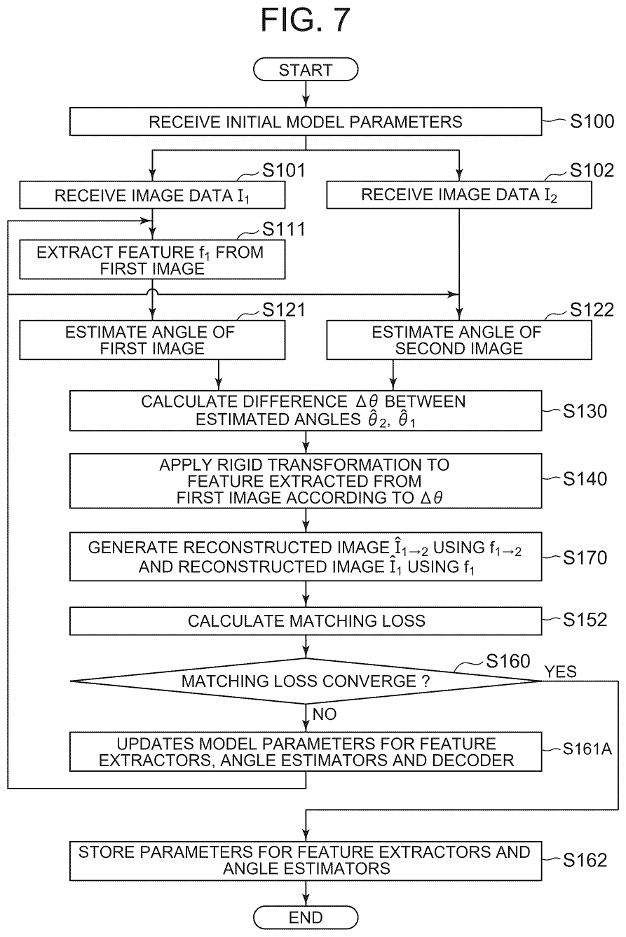

Next, the operation of the training apparatus 103 will be explained with reference to the flowchart in FIG. 7. The operation of steps S100, S101, S102, S111, S121, S122, S130, S140, S160, S162 is the same as it of the training apparatus 101 shown in FIG. 2.

In the present example embodiment, the decoder 170 generates a reconstructed image I\hat{ }_{1 to 2} using the transformed feature f_{1 to 2} obtained from the feature f₁ by the rigid transformation section 140 (step S170). The decoder 170 further generates a reconstructed image I\hat{ }₁ using the feature f₁ in step S170.

The matching loss computation section 152 calculates the difference between the reconstructed image I\hat{ }_{1 to 2} and the image data I₂, and the difference between the reconstructed image I\hat{ }₁ and the image data I₁ as the matching loss (step S152). In step S161A, the model updating section 161 updates model parameters for the feature extractor 110, the first angle estimator 121, the second angle estimator 122 and the decoder 170, with reference to the matching loss calculated by the matching loss computation section 152. The model updating section 161 updates the decoder 170 so that the matching loss relative to the reconstructed images will decrease.

### Technical Effects of the Present Example Embodiment

Features are high-level abstractions of images. That is, features contain much less information than images. Thus, unlike comparing at the feature level as the previous embodiments do, the present example embodiment comparing at the image level is more robust. The reason is because, comparing the reconstructed transformed image with the original image encourages details to match, while comparing the transformed features with the non-transformed feature may ignore the details but only focus on matching the outline. In other words, the present example embodiment is expected to be more robust than the first embodiment.

### Example Embodiment 4

### Configuration of Training Apparatus

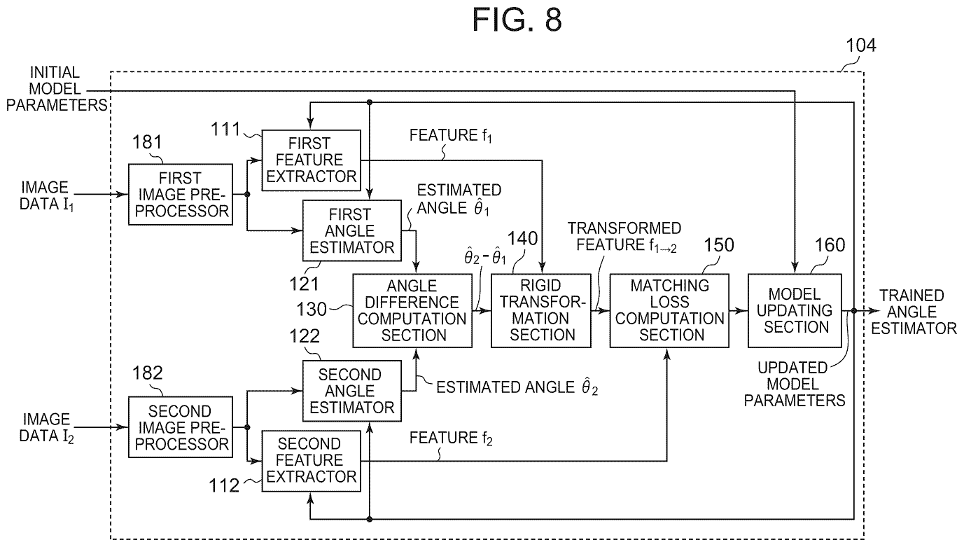

FIG. 8 is a block diagram showing a configuration example of a training apparatus of the fourth example embodiment. The training apparatus 104 shown in FIG. 8 further includes a first image pre-processor 181 and a second image pre-processor 182. The other configuration of the training apparatus 104 is the same as that of the training apparatus 101 of the first example embodiment. Note that the first image pre-processor 181 and the second image pre-processor 182 can be configured as a single section.

The first pre-processor 181 applies a predetermined pre-processing to the first image. The pre-processed image data is supplied to the first feature extractor 111 and the first angle estimator 121. The second pre-processor 182 applies a predetermined pre-processing to the second image. The pre-processed image data is supplied to the second feature extractor 112 and the second angle estimator 122.

### Operation of Training Apparatus

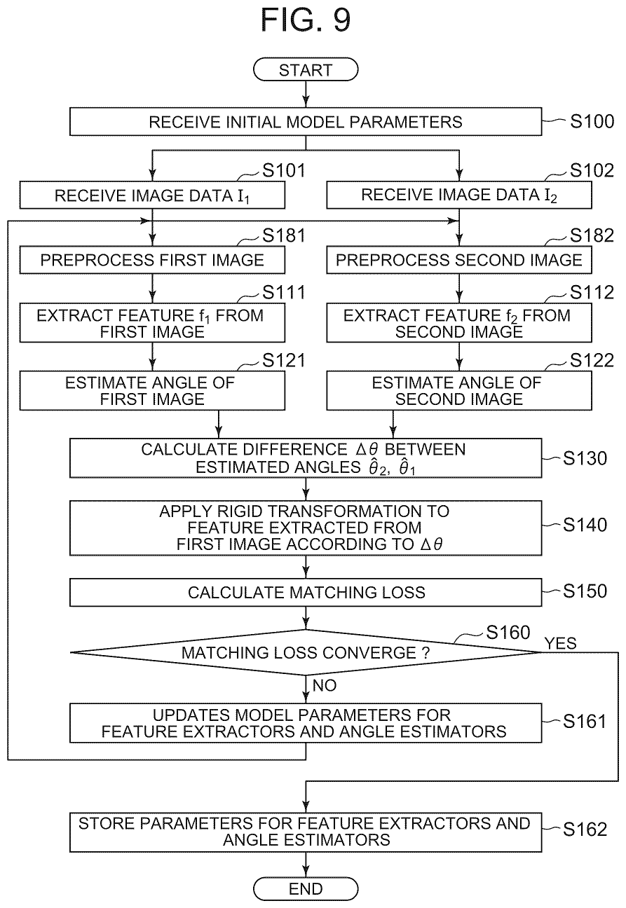

Next, the operation of the training apparatus 104 will be explained with reference to the flowchart in FIG. 9. The operation of steps S100, S101 to S150 and S160 to S162 is the same as it of the training apparatus 101 shown in FIG. 2.

In the present example embodiment, the first pre-processor 181 applies a predetermined pre-processing to the first image in step S181. Specifically, the first pre-processor 181 processes the image data I₁. The second pre-processor 182 applies a predetermined pre-processing to the second image in step S182. Specifically, the second pre-processor 182 processes the image data I₂.

One example of the pre-process is background removal. Another example of the pre-process is noise reduction. When background removal is processed, assume a picture of a car on the street is obtained. In case only the car would be recognized, the pre-processor removes the background which is the street. The background and the car can be separated using image segmentation methods, for example, and only image pixels for the car remain.

In general, images, especially SAR images, contain noises. When noise reduction is processed, the pre-processor can remove noises for optical or SAR images. The pre-processor may use median filter, Gaussian blur, Fast-Fourier Transform based methods or even learnable neural networks, etc. for removing noises.

Note that the pre-process is not limited to the background removal and the noise reduction. The pre-process can also be designed as a learnable neural network that extracts low-level features. These low-level features are shared by the feature extractors and the angle estimators. By doing so, the number of trainable parameters of the neural network can be reduced. In other words, the training of the network can be more efficient.

### Technical Effects of the Present Example Embodiment

By removing the background or noise reduction for example, the extracted features contain merely or mainly the information of the objects. This encourages the angle estimation to be more accurate.

### Example Embodiment 5

### Configuration of Training Apparatus

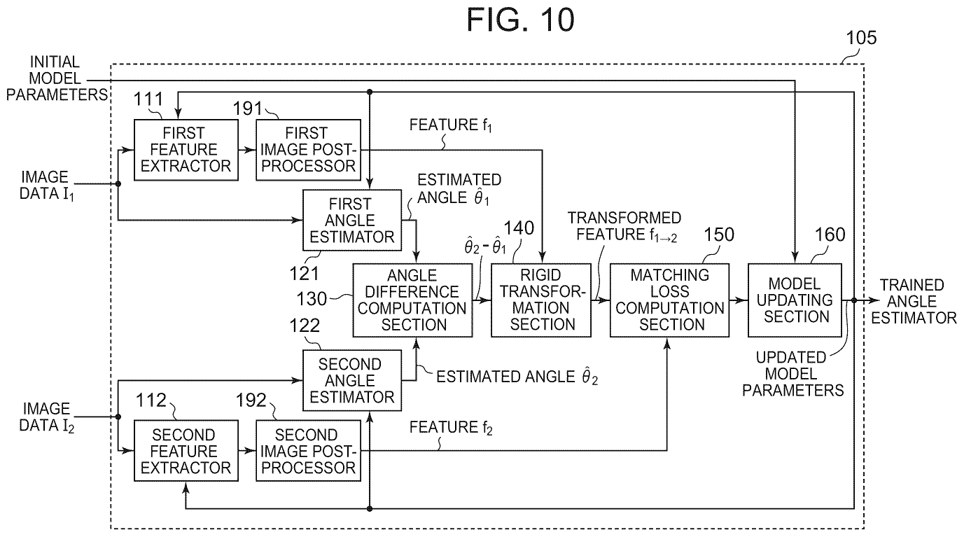

FIG. 10 is a block diagram showing a configuration example of a training apparatus of the fifth example embodiment. The training apparatus 105 shown in FIG. 10 further includes a first image post-processor 191 and a second image post-processor 192. The other configuration of the training apparatus 105 is the same as that of the training apparatus 101 of the first example embodiment. Note that the first image post-processor 191 and the second image post-processor 192 can be configured as a single section.

In the present example embodiment, the first post-processor 191 applies a predetermined post-processing to the feature extracted by the first feature extractor 111. The post-processed feature is supplied to the rigid transformation section 140 as the feature f₁. The second post-processor 192 applies a predetermined post-processing to the feature extracted by the second feature extractor 112. The post-processed feature is supplied to the matching loss computation section 150 as the feature f₂.

### Operation of Training Apparatus

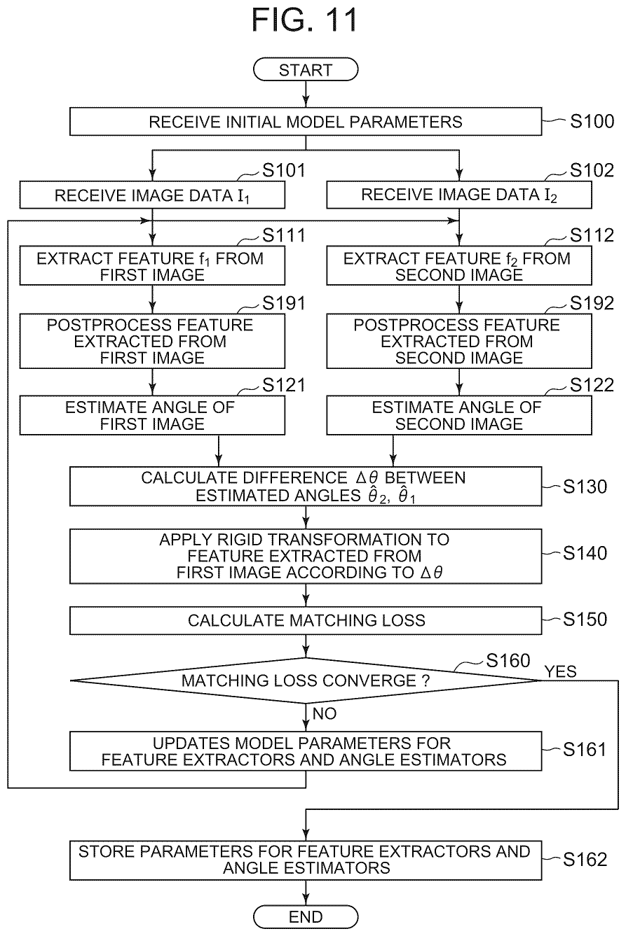

Next, the operation of the training apparatus 105 will be explained with reference to the flowchart in FIG. 11. The operation of steps S100, S101 to S150 and S160 to S162 is the same as it of the training apparatus 101 shown in FIG. 2.

In the present example embodiment, the first post-processor 191 performs a predetermined post-process to the feature extracted by the first feature extractor 111. Specifically, the first post-processor 191 performs processing to enable angle estimation to be performed more accurately. The second post-processor 192 performs a predetermined post-process to the feature extracted by the second feature extractor 112. Specifically, the second post-processor 192 performs processing to enable angle estimation to be performed more accurately.

One example of the post-process is normalization. Another example of the post-process is masking. When normalization is performed, assume the features are 3D point clouds, for example. By performing point normalization, coordinates of all points are normalized in the range [0, 1]. Before normalization, coordinates of some points may have very large values, e.g. 10, while some may be very small, e.g. 0.1, the large difference causes the matching loss to be very large. As a result, the model is not easy to train. However, in the present example embodiment, normalization suppresses the unwanted increase in matching loss.

When masking is performed, assume the features are feature maps, for example, then after rigid transformation, values at the boundary are lost. A masking filter only retains the values in the central part. In the present example embodiment, masking is used to make the transformed features, which has values lost at the boundary, to be comparable to the non-transformed features at the boundary. Note that the post-process is not limited to normalization or masking, it can be some learnable neural networks such as conditional generative networks, etc.

### Technical Effects of the Present Example Embodiment

By point normalization or feature map masking, the features (including transformed features and non-transformed features) are more suitable for comparison. This encourages the angle estimation to be more accurate.

### Example Embodiment 6

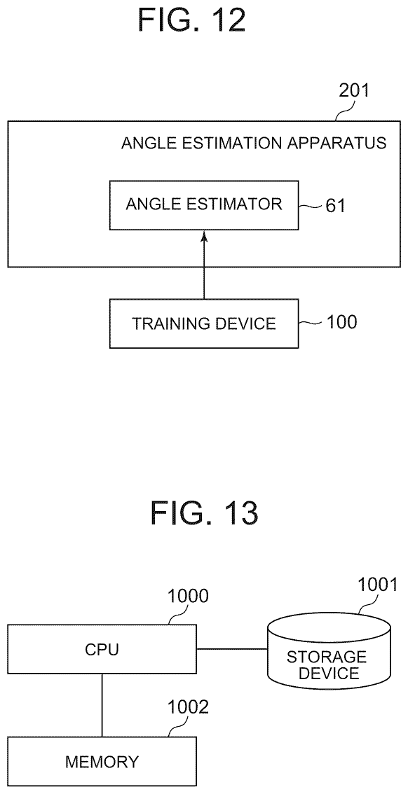

FIG. 12 is a block diagram showing a configuration example of an angle estimation apparatus of the sixth example embodiment. The angle estimation apparatus 201 shown in FIG. 12 includes an angle estimator 61. The angle estimator 61 is a device trained by the training device 100.

The training device 100 is equivalent to any of the training apparatuses 101-105 of the first to fifth embodiments. The angle estimator 61 is equivalent to the first angle estimator 121 or the second angle estimator 122 extracted from any of the training apparatuses 101-105 of the first to fifth embodiments, for example.

Thus, the angle estimator 61 can be trained by the training device 100 as described in the first to fifth embodiments.

The angle estimator 61 of the present example embodiment can estimate the angle information in an input image correctly.

Each component in each of the above example embodiments may be configured with a piece of hardware or a piece of software. Alternatively, the components may be configured with a plurality of pieces of hardware or a plurality of pieces of software. Further, part of the components may be configured with hardware and the other part with software.

The functions (processes) in the above example embodiments may be realized by a computer having a processor such as a central processing unit (CPU), a memory, etc. For example, a program for performing the method (processing) in the above example embodiments may be stored in a storage device (storage medium), and the functions may be realized with the CPU executing the program stored in the storage device.

FIG. 13 is a block diagram showing an example of a computer with a CPU. The computer is implemented in a training apparatus or an angle estimation apparatus. The CPU 1000 executes processing in accordance with a program stored in a storage device 1001 to realize the functions in the above example embodiments. That is to say, the computer can realize the functions of the first feature extractor 111, the second feature extractor 112, the first angle estimator 121, the second angle estimator 122, the angle difference computation section 130, the first angle difference computation section 131, the second angle difference computation section 132, the rigid transformation section 140, the first rigid transformation section 141, the second rigid transformation section 142, the matching loss computation section 150, 151, 152, the model updating section 160, 161, the decoder 170, the first image pre-processor 181, the second image pre-processor 182, the first image post-processor 191 and the second image post-processor 192 in the training apparatuses shown in FIGS. 1, 4, 6, 8 and 10, by executing the program stored in the storage device 1001.

The computer can realize the function of the angle estimator 61 in the angle estimation apparatus shown in FIG. 12, by executing the program stored in the storage device 1001.

A storage device 1001 is, for example, a non-transitory computer readable media. The non-transitory computer readable medium is one of various types of tangible storage media. Specific examples of the non-transitory computer readable media include a magnetic storage medium (for example, hard disk), a magneto-optical storage medium (for example, magneto-optical disc), a compact disc-read only memory (CD-ROM), a compact disc-recordable (CD-R), a compact disc-rewritable (CD-R/W), and a semiconductor memory (for example, a mask ROM, a programmable ROM (PROM), an erasable PROM (EPROM), a flash ROM).

The program may be stored in various types of transitory computer readable media. The transitory computer readable medium is supplied with the program through, for example, a wired or wireless communication channel, or, through electric signals, optical signals, or electromagnetic waves.

The memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

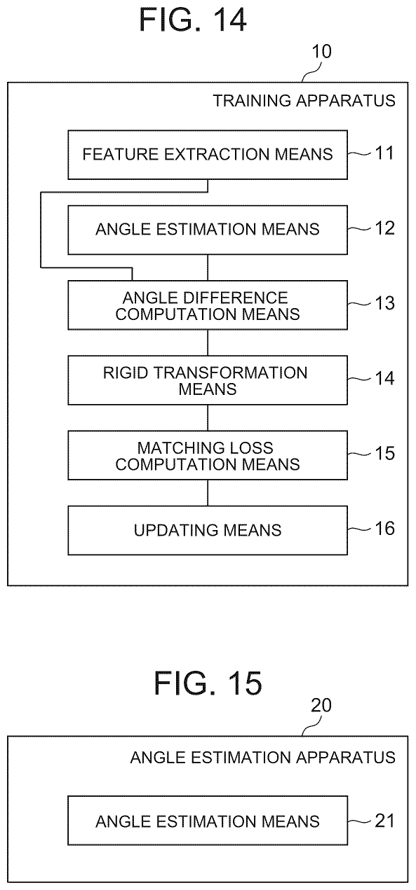

FIG. 14 is a block diagram showing the main part of the training apparatus. The training apparatus 10 shown in FIG. 14 comprises one or more feature extraction means 11 (in the example embodiments, realized by the first feature extractor 111 and the second feature extractor 112) for extracting features from input images, one or more angle estimation means 12 (in the example embodiments, realized by the first angle estimator 121 and the second angle estimator 122) for estimating angles from the input images, angle difference computation means 13 (in the example embodiments, realized by the angle difference computation section 130, or the first angle difference computation section 131 and the second angle difference computation section 132) for calculating a difference between angles estimated by the one or more angle estimation means, rigid transformation means 14 (in the example embodiments, realized by the rigid transformation section 140, or the first rigid transformation section 141 and the second rigid transformation section 142) for transforming the feature of the input image according to the difference, matching loss computation means 15 (in the example embodiments, realized by the matching loss computation section 150, the matching loss computation section 151 or the matching loss computation section 152) for calculating a matching loss between a non-transformed feature (the feature which is not transformed by the rigid transformation means 14) extracted by the one or more feature extraction means 11 and the feature transformed by the rigid transformation means 14, and updating means 16 (in the example embodiments, realized by the model updating section 160 or the model updating section 161) for updating at least the one or more angle estimation means 12 with reference to the matching loss, wherein the rigid transformation means 14 transforms the feature in a way that the feature appears as if it has been extracted from an image at the same angle of the image from which the non-transformed feature value has been extracted.

FIG. 15 is a block diagram showing the main part of the angle estimation apparatus. The angle estimation 20 shown in FIG. 15 comprises an angle estimation means 21 (in the example embodiments, realized by the angle estimator 61) for estimating an angle from an input image, wherein the angle estimation means 21 has been trained together with one or more feature extraction means and rigid transformation means, in such a way as the extracted image feature, after being transformed according to the estimated angle, appears as if it was extracted from an image at an angle different from the original input image.

In each of the example embodiments described above, images are typically SAR images. However, the images are not limited to SAR images. As an example, the images can also be optical images, for example, images photographed by a smart phone.

Since the trained angle estimation apparatus of the above embodiment can estimate the angle information of an image correctly, the trained angle estimation apparatus can be integrated into other image processing system to provide angle information to improve overall performance of the system. For example, when the angle estimation apparatus of the above embodiment provides an estimated head pose of a human face image to a face recognition system, the recognition accuracy of the system is improved due to the system having extra knowledge about the human head pose.

A part of or all of the above example embodiments may also be described as, but not limited to, the following supplementary notes.

(Supplementary Note 1) A training apparatus comprising:
one or more feature extraction means for extracting features from input images,
one or more angle estimation means for estimating angles from the input images,
angle difference computation means for calculating a difference between angles estimated by the one or more angle estimation means,
rigid transformation means for transforming the feature of the input image according to the difference,
matching loss computation means for calculating a matching loss between a non-transformed feature extracted by the one or more feature extraction means and the feature transformed by the rigid transformation means, and
updating means for updating at least the one or more angle estimation means with reference to the matching loss,
wherein
the rigid transformation means transforms the feature in a way that the feature appears as if it has been extracted from an image at the same angle of the image from which the non-transformed feature value has been extracted.

(Supplementary note 2) The training apparatus according to Supplementary note 1, wherein the updating means also updates the one or more feature extraction means.

(Supplementary note 3) The training apparatus according to Supplementary note 1 or 2, further comprising
one or more pre-processor for applying a predetermined pre-processing to the input images to supply pre-processed images to the one or more feature extraction means and the one or more angle estimation means.

(Supplementary note 4) The training apparatus according to Supplementary note 1 or 2, further comprising
one or more post-processor for applying a predetermined post-processing to the features extracted by the one or more feature extraction means and the features outputted by the rigid transformation means.

(Supplementary note 5) A training apparatus comprising:
one or more feature extraction means for extracting features from input images,
one or more angle estimation means for estimating angles from the input images,
one or more angle difference computation means for calculating a difference between the angle estimated by the one or more angle estimation means and an angle of a canonical view,
one or more rigid transformation means for transforming a non-transformed feature extracted by the one or more feature extraction means according to the difference,
matching loss computation means for calculating a matching loss between the features transformed by the one or more rigid transformation means, and
updating means for updating at least the one or more angle estimation means, and the one or more feature extraction means, with reference to the matching loss,
wherein
the rigid transformation means transforms the feature in a way that the feature appears as if it has been extracted from an image at the same angle of the image from which the non-transformed feature value has been extracted.

(Supplementary note 6) A training apparatus comprising:
feature extraction means for extracting feature from an input image,
one or more angle estimation means for estimating angles from input images,
angle difference computation means for calculating a difference between angles estimated by the one or more angle estimation means,
rigid transformation means for transforming the feature of the input image according to the difference,
image reconstruction means for reconstructing an image using the feature extracted by the feature extraction means and reconstructing an image using the feature transformed by the rigid transformation means,
matching loss computation means for calculating a matching loss between the image reconstructed from the transformed feature and the input image at the same angle that the feature was transformed to, and between the image reconstructed from the feature without rigid transformation and the input image from which the feature was extracted, and
updating means for updating at least the one or more angle estimation means, the feature extraction means and the image reconstruction means, with reference to the matching loss,
wherein
the rigid transformation means transforms the feature in a way that the feature appears as if it has been extracted from an image at the same angle of the image from which the feature value has been extracted.

(Supplementary note 7) The training apparatus according to any one of Supplementary notes 1 to 6, wherein
the matching loss computation means calculates the matching loss repeatedly until the matching loss converges.

(Supplementary note 8) An angle estimation apparatus comprising:
an angle estimation means for estimating an angle from an input image,
wherein
the angle estimation means has been trained together with one or more feature extraction means and rigid transformation means, in such a way as the extracted image feature, after being transformed according to the estimated angle, appears as if it was extracted from an image at an angle different from the original input image.

(Supplementary note 9) A training method for training an apparatus having one or more angle estimation means, comprising:
extracting features from input images,
estimating angles from the input images by one or more angle estimation means,
calculating a difference between estimated angles,
rigid-transforming the extracted feature of the input image according to the difference,
calculating a matching loss between a non-transformed feature and the rigid-transformed feature, and
updating at least the one or more angle estimation means with reference to the matching loss,
wherein
the transformed feature is transformed in a way that it appears as if it has been extracted from an image at the same angle of the image from which the non-transformed feature has been extracted.

(Supplementary note 10) The training method for training the apparatus having one or more feature extraction means according to Supplementary note 9,
wherein
the one or more feature extraction means are updated with reference to the matching loss.

(Supplementary note 11) An angle estimation method comprising:
estimating an angle from an input image, using an angle estimation apparatus which has been trained together with one or more feature extraction means and rigid transformation means, in such a way as the extracted image feature, after being transformed according to the estimated angle, appears as if it was extracted from an image at an angle different from the original input image.

(Supplementary note 12) A computer readable information recording medium storing a training program, for training an apparatus having one or more angle estimation means, causing a computer to execute:
extracting features from input images,
estimating angles from the input images by one or more angle estimation means,
calculating a difference between estimated angles,
rigid-transforming the feature of the input image according to the difference,
calculating a matching loss between a non-transformed feature and the rigid-transformed feature, and
updating at least the one or more angle estimation means with reference to the matching loss,
wherein
the transformed feature is transformed in a way that it appears as if it has been extracted from an image at the same angle of the image from which the non-transformed feature has been extracted.

(Supplementary note 13) The computer readable information recording medium according to Supplementary note 12, wherein
the training program causes the computer capable of realizing one or more feature extraction means for extracting features from input images, to further execute,
updating the one or more feature extraction means with reference to the matching loss.

(Supplementary note 14) A computer readable information recording medium storing an angle estimation program causing a computer to execute:
estimating angles from the input images, using an angle estimation apparatus which has been trained together with one or more feature extraction means and rigid transformation means, in such a way as the extracted image feature, after being transformed according to the estimated angle, appears as if it was extracted from an image at an angle different from the original input image.

Although the invention of the present application has been described above with reference to example embodiments, the present invention is not limited to the above example embodiments. Various changes can be made to the configuration and details of the present invention that can be understood by those skilled in the art within the scope of the present invention.

### REFERENCE SIGNS LIST

10, 101-105 Training apparatus
11 Feature extraction means
12 Angle estimation means
13 Angle difference computation means
14 Rigid transformation means
15 Matching loss computation means
16 Updating section
20, 201 Angle estimation apparatus
21 Angle estimation means
61 Angle estimator
100 Training device
111 First feature extractor
112 Second feature extractor
121 First angle estimator
122 Second angle estimator
130 Angle difference computation section
131 First angle difference computation section
132 Second angle difference computation section
140 Rigid transformation section
141 First rigid transformation section
142 Second rigid transformation section
150, 151, 152 Matching loss computation section
160, 161 Model updating section
170 Decoder
181 First image pre-processor
182 Second image pre-processor
191 First image post-processor
192 Second image post-processor

What is claimed is:

1. A training apparatus comprising:
A training apparatus comprising:
a memory storing software instructions, and
one or more processors configured to execute the software instructions to implement
one or more feature extraction sections which extract features from input images,
one or more angle estimation sections which estimate angles from the input images,
an angle difference computation section which calculates a difference between angles estimated by the one or more angle estimation sections,
a rigid transformation section which transforms the feature of the input image according to the difference,
a matching loss computation section which calculates a matching loss between a non-transformed feature extracted by the one or more feature extraction means sections and the feature transformed by the rigid transformation section, and
an updating section which updates at least the one or more angle estimation sections with reference to the matching loss,
wherein
the one or more processors are configured to execute the software instructions to transform the feature in a way that the feature appears as if it has been extracted from an image at the same angle of the image from which the non-transformed feature value has been extracted.

2. The training apparatus according to claim 1, wherein
the one or more processors are configured to execute the software instructions to also update the one or more feature extraction sections.

3. The training apparatus according to claim 1, wherein
the one or more processors are further configured to execute the software instructions to implement one or more pre-processors which apply a predetermined pre-processing to the input images to supply pre-processed images to the one or more feature extraction sections and the one or more angle estimation sections.

4. The training apparatus according to any one of claim 1, wherein
one or more post-processor for applying the one or more processors are further configured to execute the software instructions to implement one or more post-processors which apply a predetermined post-processing to the features extracted by the one or more feature extraction sections and the features outputted by the rigid transformation section.

5-6. (canceled)

7. The training apparatus according to claim 1, wherein
the one or more processors are configured to execute the software instructions to calculate the matching loss repeatedly until the matching loss converges.

8. An angle estimation apparatus comprising:
a memory storing software instructions, and
one or more processors configured to execute the software instructions to implement
an angle estimation section which estimates an angle from an input image,
wherein
the angle estimation section has been trained together with one or more feature extraction sections and rigid transformation section, in such a way as the extracted image feature, after being transformed according to the estimated angle, appears as if it was extracted from an image at an angle different from the original input image.

9. A training method for training an apparatus having one or more angle estimation sections, comprising:
extracting features from input images,
estimating angles from the input images by the one or more angle estimation sections,
calculating a difference between estimated angles,
rigid-transforming the extracted feature of the input image according to the difference,
calculating a matching loss between a non-transformed feature and the rigid-transformed feature, and
updating at least the one or more angle estimation sections with reference to the matching loss,
wherein
the transformed feature is transformed in a way that it appears as if it has been extracted from an image at the same angle of the image from which the non-transformed feature has been extracted.

10. The training method for training the apparatus having one or more feature extraction sections according to claim 9,
wherein
the one or more feature extraction sections are updated with reference to the matching loss.

11-14. (canceled)
